(19) United States
(12) Patent Application Publication
(10) Pub. No.: US 2008/0143475 A1
(43) Pub. Date: Jun. 19, 2008

(54) UTILITY CONSERVATION SYSTEM AND METHOD THEREFOR

(76) Inventor: George Turkovich, Las Vegas, NV (US)

Correspondence Address: WEISS & MOY PC, 4204 NORTH BROWN AVENUE, SCOTTSDALE, AZ, 85251, US

(21) Appl. No.: 12/020,346

(22) Filed: Jan. 25, 2008

Related U.S. Application Data
(63) Continuation-in-part of application No. 11/034,900, filed on Jan. 13, 2005.

(51) Int. Cl. G05B 19/02

(52) U.S. Cl. 340/5.2

(57) ABSTRACT

A conservation system for a building area has an access device to allow entry into the building area. The access device is programmed with a predetermined amount of electricity usage. A system control device is used for detecting the access device and sends wireless signals of detection. An interrupt device is used for receiving the wireless signals of detection and for controlling operation of electrical devices. The interrupt device allows operation of an electrical device when the system controller detects the access device. The interrupt device transmits usage data to the system controller of the amount of electricity being drawn by the electrical device. The system controller will receive the usage data and compare the usage data to the predetermined amount of electricity usage. The system controller allows operation of the electrical device if a total amount of the usage data is less than the predetermined amount of electricity usage.

### RELATED APPLICATIONS

The present patent application is a Continuation-In-Part of a patent application having Ser. No. 11/034,900, filed Jan. 13, 2005, in the name of the same inventors as the present patent application and entitled “UTILITY CONSERVATION SYSTEM AND METHOD THEREFOR”.

### FIELD OF THE INVENTION

This invention relates generally to utility conservation, and, more particularly, to a conservation system for building areas requiring an access device to gain entry.

### DESCRIPTION OF THE RELATED ART

Conservation of utilities, such as power, water, and gas, has become a prominent concern for building owners and managers. The recent increase in power and gas costs resulting from the unrest in the Middle East as well as supply problems from other oil-producing countries has impacted the profitability of businesses that must maintain building areas such as hotel room and office buildings. Additionally, drought conditions throughout areas of the United States has resulted in increased water charges, restrictions on water use, and penalties for exceeding such restrictions. However, several problems are faced by such businesses attempting to reduce the usage of utilities.

One fundamental obstacle for businesses that lease building space is a non-conservation mindset of tenants. Hotel guest, for example, often believe that because power and water costs are apportioned equally among all hotel guest and included in a flat rate for the hotel room, their utility usage is “pre-paid.” Additionally, the guest that attempts to minimize consumption ultimately ends up subsidizing the consumption of guests that do not, providing a disincentive for such behavior.

A significant portion of utility consumption results from usage when the occupant is not present in the room. Hotel guests typically leave their air-conditioner or heater thermostat at a comfortable position even while absent, so that the room will remain at a comfortable temperature upon their return. Additional consumption occurs when the guests leave on lights, televisions, radios, and other appliances during their absence. Other acts such as leaving window curtains open during the summer days or not promptly reporting running toilets or faucets further increases the unnecessary consumption of utilities.

In the case of heating or air-conditioning, however, it is often most efficient to allow the appliance to continue operating at reduced levels during unoccupied periods in order to reduce the energy required to quickly bring the room back to a comfortable temperature when as occupant returns. This may be accomplished by having the occupant set a thermostat upon exiting and again upon returning. However, in situations such as hotel rooms, it may be prohibitively difficult to educate each guest about such a conservation policy, and even more difficult to enforce the policy. As an additional complication, often hotel rooms do not have an adjustable thermostat and instead simply have air conditioners or heaters that only operate as “on” or “off” according to the occupant's selection.

One attempt to solve this problem uses a hotel room key card holder mounted to a wall near the entryway and having a wire running to the air conditioner. When a guest enters, he must insert his key card into the holder to allow the normal operation of the air conditioner. When the guest removes his key card, the air conditioned is operated according to a timer. However, the installation of such devices into existing hotel rooms either results in ugly wiring traveling along the walls, or the prohibitively expensive opening of wall sections to conceal the wiring. Additionally, such devices, once installed, are difficult or expensive to relocate or replace. Also, these devices only address a single source of utility waste, and do not aid in reducing other sources of waste such as described above.

A need therefore exists to provide an inexpensive system and method for reducing utility usage when a building area is unoccupied.

Another need exists to provide a system and method for reducing utility usage by several sources of consumption.

Still another need exists to provide a system and method for reducing utility usage that is not aesthetically unpleasant to occupants.

Yet another need exists to provide a system and method for reducing utility usage that allows modular installation and removal.

The present invention satisfies these needs, and provides other, related, advantages.

### SUMMARY

The foregoing objectives are achieved in the utility conservation system and method therefore.

A conservation system for a building area has an access device to allow entry into the building area. The access device is programmed with a predetermined amount of electricity usage. A system control device is used for detecting the access device and sends wireless signals of detection. An interrupt device is used for receiving the wireless signals of detection and for controlling operation of electrical devices. The interrupt device allows operation of an electrical device when the system controller detects the access device. The interrupt device transmits usage data to the system controller of the amount of electricity being drawn by the electrical device. The system controller will receive the usage data and compare the usage data to the predetermined amount of electricity usage. The system controller allows operation of the electrical device if a total amount of the usage data is less than the predetermined amount of electricity usage.

The foregoing and other objects, features, and advantages of the invention will be apparent from the following, more particular, description of the preferred embodiments of the invention, as illustrated in the accompanying.

### BRIEF DESCRIPTION OF THE DRAWINGS

Embodiments of the disclosure will become more fully understood from the detailed description and the accompanying drawings, wherein:

FIG. 1 is an illustration depicting a perspective view of a system control device in accordance with embodiments of the present invention.

FIG. 2 is an illustration depicting a perspective view showing an interruption device in a cutaway portion in accordance with embodiments of the present invention.

FIG. 3 is an illustration depicting a cutaway perspective view of the interior of the system control device of FIG. 1.

FIG. 4 is an illustration depicting a perspective front view and back view of an interruption device in accordance with embodiments of the present invention.

FIG. 5 is an illustration depicting a perspective front view and a perspective back view of an interruption device in accordance with embodiments of the present invention.

FIG. 6 is an illustration depicting a perspective view of interruption devices in accordance with embodiments of the present invention.

FIG. 7 is an illustration depicting a perspective view of an interruption device in accordance with embodiments of the present invention.

FIG. 8A is a block diagram showing components of an interruption device in accordance with embodiments of the present invention.

FIG. 8B is a block diagram showing components of an interruption device in accordance with embodiments of the present invention.

### DETAILED DESCRIPTION

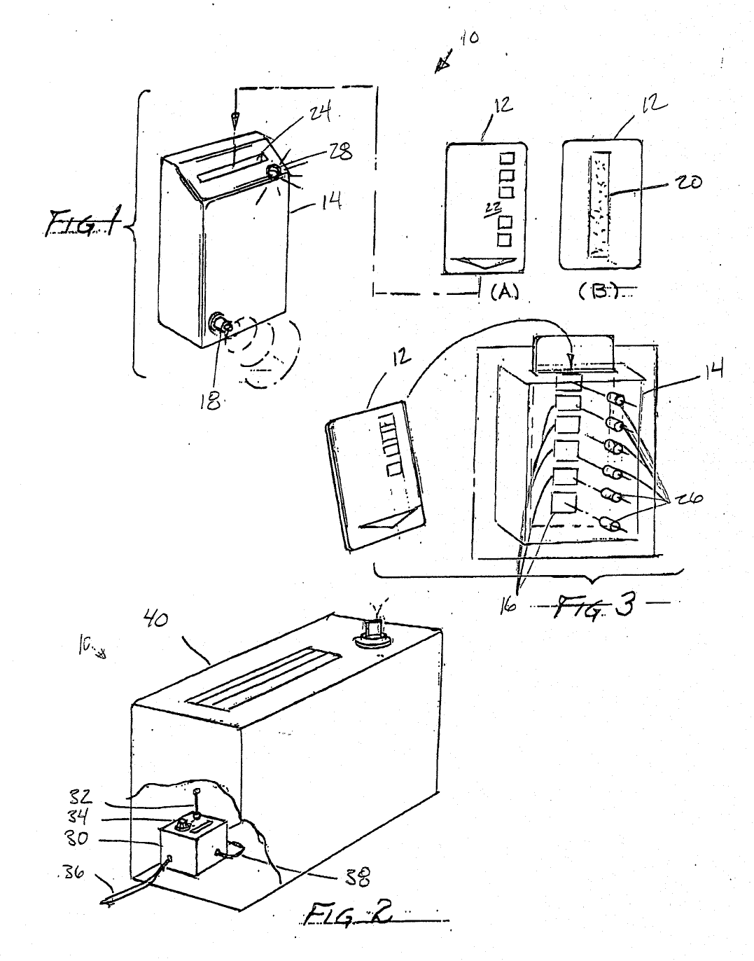

With reference now to the Figures, and in particular to FIGS. 1, 2, and 3, a conservation system 10 for a building area requiring an access device 12 to gain entry is shown in accordance with a first embodiment of the present invention. Conservation system 10 includes a system control device 14 having a sensor 16 for detecting the access device 12. The system control device 14 also includes a transmitter 18 coupled to the sensor 16 for wirelessly transmitting a result of detecting the access device 12. The system 10 further includes an interruption device 30 for interrupting use of a resource controlled by system 10. Interruption device 10 operates according to receiving a wireless signal from the transmitter 18. Appliances and other devices connect to an interruption device 30 may then be automatically shut off or selectively controlled when the building area is unoccupied, conserving unnecessary power consumption.

It is envisioned that the building area is a hotel room or suite that typically experiences high power consumption while unoccupied, such as hotel guests that leave the air-conditioning running when they leave for prolonged periods. However, conservation system 10 may generate substantial benefits for any building area, such as individual office, office building, private residence or the like.

One notable benefit of the present invention is the simplicity of installation obtained by using wireless communication between the system control device 14 and one or more interruption devices 30. Each component of the system 10 may be installed without requiring the choice of having unsightly wires running between components or the expense of running wires within existing walls. Furthermore, the modular nature of the system 10 allows flexibility as components may be added, removed, or relocated as desired with minimal effort.

Returning to FIGS. 1 and 3, the access device 12 is preferably a key card and the system control device 14 has a holder 24 for holding the key card once inserted. In one embodiment, the access device 12 has a magnetic stripe 20 (FIG. 1B), and the sensor 16 detects the magnetic stripe 20 when the access device 12 is positioned in the holder 24. In another embodiment, the access device 12 has an opaque portion 22 (FIG. 1A). The system control device 14 has a light source 26 and the sensor 16 detects light. The holder 24 holds the access device 12 between the sensor 16 and the light source 26 so that the system control device 14 detects when the opaque portion 22 of the access device 12 is in between the light source 26 and the sensor 16. However, it should be understood that it is within the spirit and scope of the present invention that the access device 12 may not be a key card, so long as the access device 12 is capable of being detected by the sensor 16. For example, the access device 12 may be a traditional key, a security badge, or the like.

The system control device 14 preferably holds the access device 12 while the building area is occupied, so that the conservation system 10 detects when an occupant enters or leaves by detecting the presence or absence of the access device 12 in the holder 24. Using as an example a hotel room having a key card, various room appliances such as television and lamps may be connected to one or more interruption devices 30 to not function unless the key card remains in the holder 24. In order to leave the room and regain entry later, a hotel guest must remove the key card upon leaving. A light 28 may be provided on the system control device 12 to act as a visual reference when the building area is dark, or as a visual reminder to remove the access device 12 from the holder 24 upon egress, by flashing, or remaining on steadily, or any other desired operation of the light 28.

It should be clearly understood that certain benefits may be obtained by the system control device 14 releasing or not requiring continual contact with the access device 12, as long as the access device 12 is detected upon entry and egress from the building area. For example, the system control device 14 for a hotel room may be located outside the entry door and also function to unlock or lock the door upon swiping a key card. As another example, the sensor 16 may detect a nearby access device 12 through well-known techniques such as inductive resonance.

It is preferred that the wireless transmission by the transmitter 18 of the system control device 14 may be any suitable type of transmission well-known in the art such as by RF, IR, microwave, or any other suitable transmission type. Preferably, the transmission is of sufficient strength to be detectable throughout the building area, but not interfere with other systems in nearby building areas such as adjacent hotel rooms. Potential interference may be minimized by using various frequencies or identifiers, as discussed below.

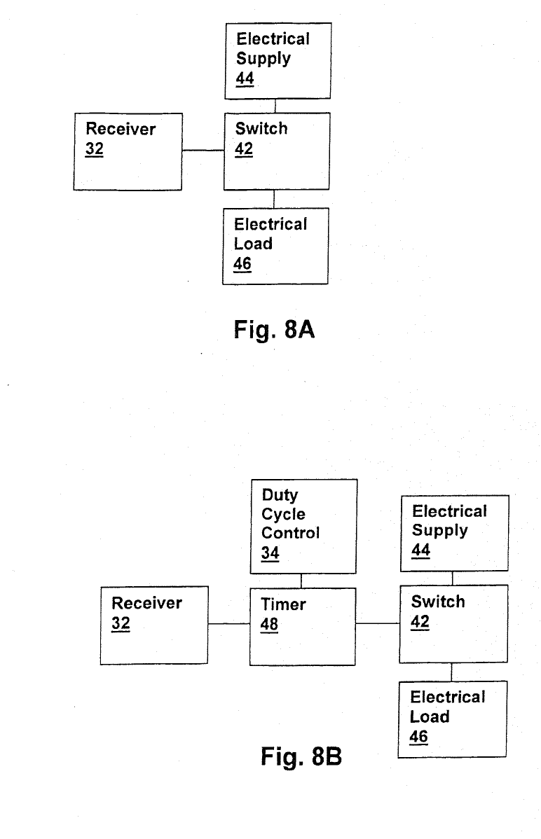

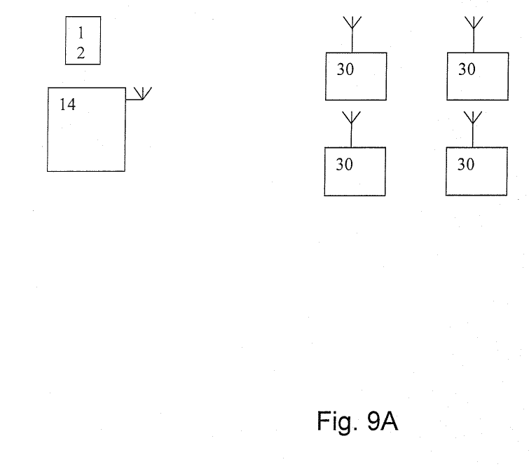

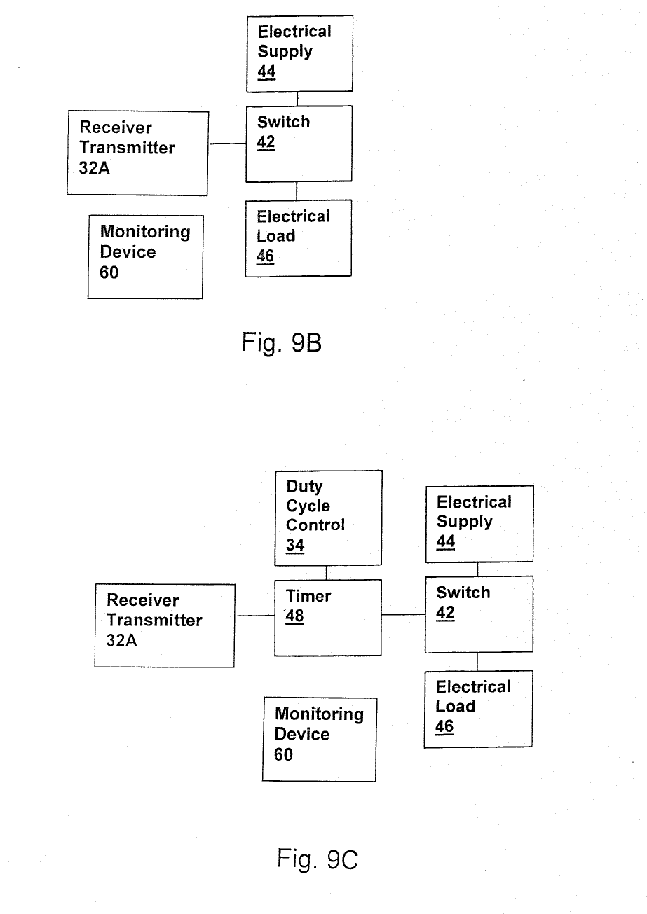

Turning now to FIG. 8A, components of an interruption device 30 in accordance with an embodiment of the present invention are shown in a block diagram. A receiver 32 is coupled to a switch 42 that is coupled between an electrical supply 44 and an electrical load 46. The switch 42 may be a transistor, solenoid switch, or any other appropriate device for allowing or interrupting current flow. The switch 42 operates in accordance with received transmissions from the system control device 14 resulting from the detection of the access device 12. When a transmission is received corresponding to a detection of an access device 12, the switch 42 closes, establishing electrical contact between the supply 44 and the load 46. When transmission is received corresponding to no detection of an access device 12, the switch opens isolating the electrical supply 44 from the load.

In accordance with another embodiment, the components of an interruption device 30 are shown in a block diagram in FIG. 8B. Instead of simply opening a switch 42 to isolate the electrical supply 44 from the load 46 when an access device 12 is not detected, a timer 48 and duty cycle control 34 controls the operation of the switch 42. In the embodiment depicted in FIG. 8B, appliances such as air conditioners and refrigerators may operate when the room is unoccupied according to the designed duty cycle. For example, an interruption device 30 for an air conditioner may have a duty cycle set for 10 minutes of operation followed by 50 minutes of non-operation. The duty cycle may be set to maximize efficiency by providing a reduced amount of cooling when the building area is unoccupied while still maintaining a lower than ambient temperature in order to more efficiently return the area to room temperature when an occupant returns.

Returning to FIG. 2, an interruption device 30 is depicted having an air conditioner 40 as an electrical load 46 in accordance with an embodiment of the present invention 10. Preferably the interruption device 30 is located inside the housing of the air conditioner 40 to reduce tampering and improve aesthetics. Although the interruption device 30 is depicted in FIG. 2 as having a fixed power supply line 36 providing power from a power supply 44 and output line 38 extending to the air conditioner 40 electrical input, it is within the spirit and scope of the present invention that the power supply line 36 and output line 38 may not be fixed. Instead, one or both may comprise conventional plugs and receptacles corresponding to conventional 110V or 220V or any other desired type for ease of installation and removal.

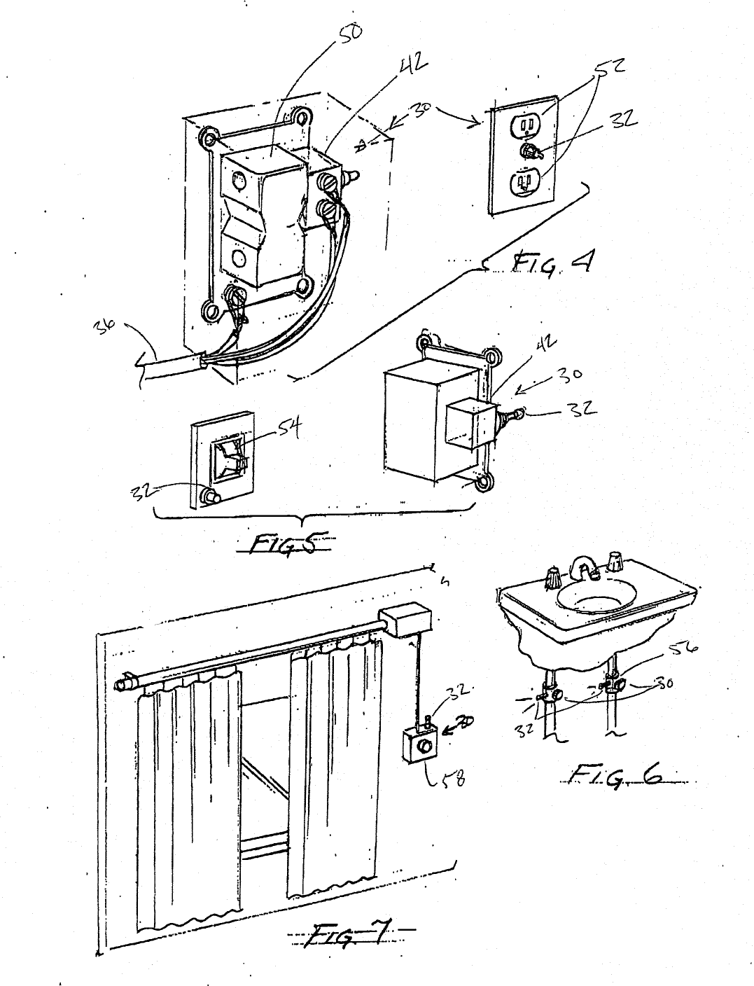

Turning now to FIG. 4, an interruption device 30A is depicted in accordance with another embodiment of the present invention having a wall mounted electrical receptacle 50 for controlling an operation of an appliance plugged into the wall mounted electrical receptacle 50. Line 36 connects the switch 42 to a power supply 44. The switch connects or interrupts the electrical flow to one or both outlets 52 in response to receiving a signal via receiver 32.

In accordance with another embodiment of the present invention, a manual switch 54 may be coupled between the electrical supply and the electrical load. FIG. 5 illustrates an embodiment of the invention having the interruption device 30 serially attached to a wall-mounted manual switch 54 such as a light switch. When the access device 12 is detected by the system control device 14 the connection between the electrical supply 44 and load 46 is controlled by the manual switch 54. When the access device 12 is not detected, the switch 32 interrupts the connection between the electrical supply 44 and load 46. However, it should be understood that certain benefits may be obtained by having the switch 32 of the interruption device 30 attached in parallel to the manual switch 54 so that the manual switch 54 may establish a connection between the electrical supply 44 and load 46 even when the access device 12 is not detected by the system control device 14.

Turning now to FIG. 6, an embodiment of the present invention is shown having the electrical load 46 include an electrically-controlled valve 56 in a water supply line. In the illustrated embodiment, water flow may be controlled when the access device 12 is not detected, so that water may be conserved when the building area is unoccupied. For example, FIG. 6 depicts an example of use of a system in accordance with an embodiment of the present invention to prevent water loss from a sink that leaks or that is left running. Other examples of use include toilets, showers, ice-makers, hot water heaters, and the like. Although FIG. 6 depicts two interruption devices 30 each connected to a separate electrically-controlled valve 56 on different water lines, it should be understood that benefits may be obtained by having a single interruption device 30 operate several electrically controlled valves 56, or that not all water lines have an electrically-controlled valve 56. For example, it may be desired to only have hot-water lines controlled by the present invention 10, or only cold-water lines, as another example.

FIG. 7 shows another system in accordance with an embodiment of the present invention in which the electrical load 46 includes a motor 58 coupled to a window blind for controlling an operation of the window blind when the access device 12 is not detected. The operation of the window blind may vary according to geographic or seasonal environmental requirements. For example, during winter months it may be preferred to have window blinds automatically open when the access device 12 is not detected so that sunlight may be allowed to enter and warm the building area, in order to reduce the energy consumption required to return the area to a comfortable temperature when an occupant returns. On the other hand, during summer months it may be preferred to have window blinds automatically close when the access device 12 is not detected to prevent additional warming due to sunlight.

It is envisioned that multiple interruption devices 30 may be used as a comprehensive conservation system for a building area. For example, a building area may have interruption devices 30 on an air conditioner, electrical outlets, motorized window blinds, electrically-controlled valves, manual switches, or any combination thereof. However, it may be desirable to have only some of the interruption devices 30 operate according to the detection of the access device 12. For example, a hotel guest may desire to have some electrical outlets continue to operate when the hotel room is unoccupied, such as to operate a battery charger, while other outlets do not, such as those for a television or lamp. As another example it may be desirable to have some of the interruption devices 30 operate according to the detection of one access device 12 but not another, such as that of an office worker as opposed to a security guard or cleaning staff.

In order to enable such selective operation of the interruption device 30, it is preferred that conservation data be encoded on the access device 12 in accordance with another embodiment of the present invention. Returning to FIG. 1, the conservation data may be encoded on the access device 12 as data within a magnetic strip 20. Rather then just detecting the presence or absence of an access device 12, the system controlling device 14 may also detect the encoded conservation data and transmit the detected conservation data for reception by multiple interruption devices 30. As depicted in FIG. 3, another method of encoding the conservation data may be with the presence or absence of opaque areas 22 in the access device 12 that are detected by the transmission or interruption of light from multiple light sources 26 to light detecting sensors 16 when the access device 12 is inserted into the holder 24.

Various well-known methods may be used to convey the conservation data to the interruption devices 30. For example, each interruption device 30 may be set to only operate in response to transmissions received within a certain frequency range, so that the transmitter 18 of the system control device 14 transmits at frequencies corresponding to the detected conservation data. As another example, the transmission may instead contain interruption device identification information that each interruption device 30 receives and compares to its own identifier to determine if it should adjust its operation in response to the received transmission.

In accordance with an embodiment of the present invention, a conservation method for building area requiring an access device 12 to gain entry includes wirelessly transmitting a first signal in response to the access device 12 being proximate the building area, electrically coupling an electrical load 46 to an electrical supply 44 in response to said first signal, wirelessly transmitting a second signal in response to the access device 12 leaving the building area, and electrically decoupling the electrical load 46 from the electrical supply 44 in response to the second signal.

Preferably, the wireless transmission of the first signal is performed by an access device holder detecting an insertion of the access device 12 and the wireless transmission of the second signal is performed by the access device holder detecting a removal of the access device 12. The access device holder is preferably the system control device 14 depicted in FIG. 1 and described above, but may be any device capable of detecting the insertion of an access device 12 and transmitting a first signal in response to the insertion.

Preferably, the electrical coupling is performed by an interruption device 30 such as depicted in FIGS. 8A and 8B and described above, having a receiver 32 and a switch 42 coupled to the receiver 32, with the switch 42 being electrically coupled between the electrical supply 44 and the electrical load 46. However, it is within the spirit and scope of the present invention that the electrical coupling may instead be preformed by any other device or method so long as the electrical coupling occurs in response to the first signal.

Referring to FIG. 9A-9C, another embodiment of the present invention is shown. The system 10A still has an access device 12 to gain entry and a system control device 14 having a sensor 16 for detecting the access device 12. The system control device 14 also includes a transmitter 18 coupled to the sensor 16 for wirelessly transmitting a result of detecting the access device 12. The system 10 further includes an interruption device 30 for interrupting use of a resource controlled by system 10A.

However, in the system 10A, each access device 12 is programmed with a predetermined amount of energy usage, and/or water usage, and the like. For example, a hotel may program the access device 12 to allow a predefined number of kilowatts per person per day or per stay, a predefined number of gallons of water per person per day or per stay, and the like. Interruption devices 30 may be installed on the air conditioner 40, lights, outlets, and the like. Furthermore, as shown in FIGS. 6 and 7, the interruption device 30 may operate several electrically controlled valves 56 to control water flow to sinks, toilets, showers, ice-makers, hot water heaters, and the like as well as a motor 58 coupled to a window blind for controlling an operation of the window blind.

Each interruption device 30 will have a receiver/transmitter 32A coupled to a switch 42 that is coupled between an electrical supply 44 and an electrical load 46. The switch 42 may be a transistor, solenoid switch, or any other appropriate device for allowing or interrupting current flow. The switch 42 operates in accordance with received transmissions from the system control device 14 resulting from the detection of the access device 12. When a transmission is received corresponding to a detection of an access device 12, the switch 42 closes, establishing electrical contact between the supply 44 and the load 46.

A monitoring device 60 is coupled to the switch 42 and the receiver/transmitter 32A. Alternatively, the monitoring device 60 may be coupled to the switch 42, the receiver/transmitter 32A, and the electrically controlled valves 56. The monitoring device 60 will monitor the amount of electricity drawn through the switch 42 and/or the amount of water being drawn through the electrically controlled valves 56. The monitoring device 60 will transmit this information (electricity drawn in one embodiment, electricity and water drawn in a second embodiment) back to the system control device 14 via the receiver/transmitter 32.

The system control device 14 will receive the transmitted data sent via a receiver. The system control device 14 will store and total the different amounts transmitted. The system control device 14 will update the total amounts and compare the total amounts of electricity or electricity and water used to that programmed on the access device 12. This may be done at predetermined time periods (i.e., every 5 minutes, 15 minutes, etc.). As long as the total amount stored in the system control device 14 is below the amount programmed on the access device 12, the user will be allowed to continue to use the electricity, water, etc. However, once the total amount stored in the system control device 14 is greater then the amount programmed on the access device 12, interruption devices 30 will not function as if the access device 12 has been removed from the holder 24. This may be done in several manners. The system control device 14 will send a signal to each interruption device 30. Alternatively, the system control device 14 may deactivate the sensor 16 for detecting the access device 12. Other methods may be used without departing from the spirit and scope of the present invention.

A user may have the access device 12 reprogrammed at the front desk of the hotel to add additional amounts of energy usage, water usage, and the like added to the access device 12. However, the hotel may charge additional fees for the additional amounts added.

The embodiment shown in FIGS. 9A-9C may be used with any of the embodiments shown in the previous Figures. Thus, the system 10A may also use the duty cycle control 34 as shown in FIG. 8B or the control unit shown in FIG. 7 and the like. Also, as stated above, for safety and sanitary reasons, certain functions may remain active such as emergency lights, emergency use of the HVAC unit, toilets, or the like even if the total amount stored in the system control device 14 is greater then the amount programmed on the access device 12.

While embodiments of the disclosure have been described in terms of various specific embodiments, those skilled in the art will recognize that the embodiments of the disclosure can be practiced with modifications within the spirit and scope of the claims.

What is claimed is:

1. A conservation system for a building area comprising:
an access device to allow entry into the building area, wherein the access device is programmed with a predetermined amount of electricity usage;
a system control device for detecting the access device, the system controller sending wireless signals of detection of the access device; and
an interrupt device for receiving the wireless signals of detection of the access device and for controlling operation of an electrical device, wherein the interrupt device allows operation of an electrical device when the system controller detects the access device, the interrupt device transmitting usage data to the system controller of the amount of electricity being drawn by the electrical device;
wherein the system controller will receive the usage data transmitted by the interrupt device and compare the usage data to the predetermined amount of electricity usage, the system controller allowing operation of the electrical device if a total amount of the usage data is less than the predetermined amount of electricity usage, the system controller preventing operation of the electrical device if the total amount of the usage data is greater than the predetermined amount of electricity usage.

2. A conservation system for a building area in accordance with claim 1 wherein the interrupt device comprises:
a receiver/transmitter unit for receiving the wireless signals of detection from the system controller and for sending usage data to the system controller;
a switch coupled to the electrical device and to a power source, wherein the switch will activate and deactivate the electrical device by coupling the electrical device to the power source; and
a monitoring device coupled to the switch and the receiver/transmitter to monitor the amount of electricity drawn through the switch.

3. A conservation system for a building area in accordance with claim 2 further comprising a plurality of interrupt devices, wherein each interrupt device controls operation of a different electrical device.

4. A conservation system for a building area in accordance with claim 3 wherein one of the plurality of interrupt devices is a Heating Ventilation and Air Conditioning (HVAC) interrupt device coupled to an HVAC unit for controlling operation of the HVAC unit.

5. A conservation system for a building area in accordance with claim 4 wherein the Heating Ventilation and Air Conditioning (HVAC) interrupt device comprises:
an HVAC receiver/transmitter detection for receiving the wireless signals of detection from the system controller and for sending usage data to the system controller;
an HVAC switch coupled to the HVAC unit and to an HVAC power source, wherein the HVAC switch will activate and deactivate the HVAC unit by coupling the HVAC unit to the HVAC power source; and
an HVAC monitoring device coupled to the HVAC switch and the receiver/transmitter to monitor the amount of electricity drawn through the HVAC switch.

6. A conservation system for a building area in accordance with claim 5 wherein the Heating Ventilation and Air Conditioning (HVAC) interrupt device further comprises:
an HVAC timer coupled to the HVAC receiver/transmitter and the HVAC switch; and
an HVAC duty cycle control coupled to the HVAC timer, wherein the HVAC duty cycle will send activation/deactivation signals to the HVAC timer which signals the HVAC switch to automatically activate and deactivate the HVAC unit when the system control device does not detect the access device and if the total amount of the usage data is greater than the predetermined amount of electricity usage.

7. A conservation system for a building area in accordance with claim 4 wherein one of the plurality of interrupt devices is a window treatment interrupt device coupled to a window treatment of the building for controlling opening and closing of the window treatment, the window treatment controller allowing the person in the building area to control the opening and closing of the window treatment unit when the system control device detects the access device and if the total amount of the usage data is less than the predetermined amount of electricity usage.

8. A conservation system for a building area in accordance with claim 7 wherein the window treatment interrupt device further automatically controls opening and closing of the window treatment based on one of a time of day or time of year when the system control device does not detect the access device.

9. A conservation system for a building area in accordance with claim 7 wherein one of the plurality of interrupt devices is an electrical outlet interrupt device coupled to an electrical outlet of the building for controlling activation and deactivation of the electrical outlet, the electrical outlet controller activating the electrical outlet only when the system control device detects the access device and if the total amount of the usage data is less than the predetermined amount of electricity usage.

10. A conservation system for a building area in accordance with claim 7 wherein one of the plurality of interrupt devices is a water interrupt device coupled to an electrically controlled water valve of the building for controlling activation and deactivation of the water valve, the water controller activating the water valve only when the system control device detects the access device and if the total amount of the usage data is less than the predetermined amount of electricity usage.

11. A conservation system for a building area in accordance with claim 10 wherein the water interrupt device further monitors the amount of water drawn through the electrically controlled water valve, the water interrupt device transmitting water usage data to the system controller, the system controller will receive the water usage data transmitted and compares the water usage data to a predetermined amount of water usage programmed on the access device, the system controller allowing operation water flow through the electrically controlled water valve if a total amount of the water usage data is less than the predetermined amount of water usage.

12. A conservation system for a building area in accordance with claim 1 wherein the access device comprises a key card having a magnetic strip.

13. A conservation system for a building area comprising:
an access device to allow entry into the building area, wherein the access device is programmed with a predetermined amount of electricity usage;
a system control device for detecting the access device, the system controller sending wireless signals of detection of the access device; and
a plurality of interrupt devices for receiving the wireless signals of detection of the access device and for controlling operation of electrical devices, wherein the interrupt devices allows operation of the electrical devices when the system controller detects the access device, the interrupt devices transmitting usage data to the system controller of the amount of electricity being drawn by the electrical devices;
wherein the system controller will receive the usage data transmitted by the interrupt device and compare the usage data to the predetermined amount of electricity usage, the system controller allowing operation of the electrical device if a total amount of the usage data is less than the predetermined amount of electricity usage, the system controller preventing operation of the electrical device if the total amount of the usage data is greater than the predetermined amount of electricity usage;
wherein one of the plurality of interrupt devices is a Heating Ventilation and Air Conditioning (HVAC) interrupt device coupled to an HVAC unit for controlling operation of the HVAC unit when the system control device detects the access device and if the total amount of the usage data is less than the predetermined amount of electricity usage.
wherein one of the plurality of interrupt devices is a window treatment interrupt device coupled to a window treatment of the building for controlling opening and closing of the window treatment, the window treatment controller allowing the person in the building area to control the opening and closing of the window treatment unit when the system control device detects the access device and if the total amount of the usage data is less than the predetermined amount of electricity usage.

14. A conservation system for a building area in accordance with claim 13 wherein the Heating Ventilation and Air Conditioning (HVAC) interrupt device comprises:
an HVAC receiver/transmitter detection for receiving the wireless signals of detection from the system controller and for sending usage data to the system controller;
an HVAC switch coupled to the HVAC unit and to an HVAC power source, wherein the HVAC switch will activate and deactivate the HVAC unit by coupling the HVAC unit to the HVAC power source; and
an HVAC monitoring device coupled to the HVAC switch and the receiver/transmitter to monitor the amount of electricity drawn through the HVAC switch.

15. A conservation system for a building area in accordance with claim 14 wherein the Heating Ventilation and Air Conditioning (HVAC) interrupt device further comprises:
an HVAC timer coupled to the HVAC receiver/transmitter and the HVAC switch; and
an HVAC duty cycle control coupled to the HVAC timer, wherein the HVAC duty cycle will send activation/deactivation signals to the HVAC timer which signals the HVAC switch to automatically activate and deactivate the HVAC unit when the system control device does not detect the access device and if the total amount of the usage data is greater than the predetermined amount of electricity usage.

16. A conservation system for a building area in accordance with claim 13 wherein the window treatment interrupt device further automatically controls opening and closing of the window treatment based on one of a time of day or time of year when the system control device does not detect the access device.

17. A conservation system for a building area in accordance with claim 13 wherein one of the plurality of interrupt devices is an electrical outlet interrupt device coupled to an electrical outlet of the building for controlling activation and deactivation of the electrical outlet, the electrical outlet controller activating the electrical outlet only when the system control device detects the access device and if the total amount of the usage data is less than the predetermined amount of electricity usage.

18. A conservation system for a building area in accordance with claim 13 wherein one of the plurality of interrupt devices is a water interrupt device coupled to an electrically controlled water valve of the building for controlling activation and deactivation of the water valve, the water controller activating the water valve only when the system control device detects the access device and if the total amount of the usage data is less than the predetermined amount of electricity usage.

19. A conservation system for a building area in accordance with claim 18 wherein the water interrupt device further monitors the amount of water drawn through the electrically controlled water valve, the water interrupt device transmitting water usage data to the system controller, the system controller will receive the water usage data transmitted and compares the water usage data to a predetermined amount of water usage programmed on the access device, the system controller allowing operation water flow through the electrically controlled water valve if a total amount of the water usage data is less than the predetermined amount of water usage.

20. A conservation system for a building area in accordance with claim 13 wherein the access device comprises a key card having a magnetic strip.
